(19) United States
(12) Patent Application Publication
(10) Pub. No.: US 2014/0191687 A1
(43) Pub. Date: Jul. 10, 2014

(54) MUSIC FLASHER CONTROLLER AND THE CONTROL SYSTEM AND CONTROL METHOD THEREOF

(71) Applicant: Wei Xiang, GUANGDONG PROVINCE (CN)

(72) Inventor: Wei Xiang, GUANGDONG PROVINCE (CN)

(21) Appl. No.: 13/751,170

(22) Filed: Jan. 28, 2013

(30) Foreign Application Priority Data
Jan. 8, 2013 (CN) 201310006496.9

(51) Int. Cl. H05B 37/02

(52) U.S. Cl. CPC H05B 37/02
USPC 315/312

(57) ABSTRACT

A music flasher controller comprises a central control module, a plurality of execution modules, a plurality of light-emitting units, a power supply module, a music encoding module, a player, a signal collecting module, and a signal analysis module, thereby allowing rhythmed on/off change of the control lamp with music, exhibiting a music-light-show effect and having a flexible form, with the player not necessary to be wire-connected with the signal collecting module, thus having the advantages of easy construction, simple installation, and effective cost reduction. A music flasher control system equipped with the music flasher controller enables flexible addition or reduction of the lamp group, thus having the advantage of high scalability. A control method of the music flasher controller is also provided such that the lamp can be on/off with the music rhythm.

### BACKGROUND OF THE INVENTION

The present invention relates to a controller, more particularly to a music flasher controller that enables a lamp to be on/off with the music rhythm with a music-light-show effect; the present invention further relates to a music flasher control system equipped with the music flasher controller; the present invention still further relates to a control method for the music flasher controller.

In the field of music light show, a music flasher controller is mainly used to control a lamp to have rhythmed on/off change in accordance with the characteristic elements of a piece of music (such as melody and rhythm), so as to realize the music light show and achieve the artistic effect of the perfect combination of music and light.

However, there are one or more of the following disadvantages currently prevalent in the field of music light show:

1. Music light show can be achieved only by professional installation, with difficult construction, high cost and inconvenient maintenance;

2. the music playing source needs to be wire-connected to the lamp, making the installation tedious;

3. the number of the lamp group is not highly scalable, not allowing flexible change of the number of the lamp group according to the needs of the environment;

4. the music source is highly restricted and difficult to be updated, and the music source can only be updated even by changing or upgrading the device hardware, which is high in cost and extremely inconvenient in operation;

5. the free change and combination of the lamp group is highly restricted, with the changing pattern single and not allowing real-time change; and

6. the lamp is dull in form, and unable to realize various rhythmed changes with music.

In summary, the existing music light show has such disadvantages as complex installation, difficult construction, high cost, low scalability, and single transformation form. Therefore, the problem needing to be urgently solved is to develop a music flasher controller that has the advantages of simple installation, easy construction, low cost, high scalability, and diverse transformation form, and can make the lamp on/off with the music rhythm simply and easily.

### BRIEF SUMMARY OF THE INVENTION

A purpose of the present invention is to overcome the above disadvantages of the existing technology, and provide a music flasher controller that has the advantages of simple installation, easy construction, low cost, and diverse transformation form, and can make the lamp on/off with the music rhythm simply and easily.

Another purpose of the present invention is to overcome the above disadvantages of the existing technology, and provide a music flasher control system equipped with the music flasher controller.

Still another purpose of the present invention is to overcome the above disadvantages of the existing technology, and provide a control method for the above music flasher controller.

In order to attain the above purposes, the present invention provides the following technical solution: A music flasher controller is provided, comprising:

a central control module, used for saving lamp control codes, provided with a plurality of control output interfaces;

a plurality of execution modules, each of the execution modules being respectively connected to a control output interface at its input terminal and to a lamp input power supply for controlling the lamp input power supply to be on/off;

a plurality of light-emitting units, each of the light-emitting units being electrically connected to one of the execution modules, respectively; and

a power supply module, used for providing power supply for each of the modules.

It further comprises:

a music encoding module, used for encoding music;

a player, connected to the music encoding module, used for playing the music having been encoded by the music encoding module;

a signal collecting module, used for collecting a music signal played by the player;

a signal analysis module, connected at its input terminal to an output terminal of the signal collecting module and at its output terminal to an input terminal of the central control module, used for analyzing a music signal collected by the signal collecting module to obtain music code of the music played by the player as well as inputting the obtained music code into the central control module; and

the music encoding module and the player constitute a music encoding-playing device; and the signal collecting module, the signal analysis module, the central control module, a plurality of the execution modules, a plurality of the light-emitting units and the power supply module constitute a music signal collecting-processing control device.

The present invention provides a music flasher control system equipped with the music flasher controller, the system being composed of one music encoding-playing device and at least one music signal collecting-processing control device.

The present invention also provides a control method for the music flasher controller, which includes the following steps:

(I) Writing the lamp control code into the central control module;

(II) connecting the power supply module to initialize the central control module into which the lamp control code has been written in Step (I);

(III) encoding the music with the music encoding module;

(IV) the player plays the music that has been encoded in Step (III);

(V) the signal collecting module collects the music signal played in Step (IV), and inputs the collected music signal into the signal analysis module;

(VI) the signal analysis module real-time analyzes the music signal collected in Step (V): if the music code of the music played in Step (IV) is obtained through analysis, the obtained music code is inputted into the central control module followed by a next step, otherwise returning to Step (V) to continue;

(VII) the central control module searches and analyzes, and compares the music code inputted in Step (VI) with the saved lamp control codes: if the lamp control code consistent with the music code inputted in Step (VI) is found, entering a next step, otherwise returning to Step (V) to continue; and

(VIII) the central control module controls the execution module to execute an action appointed by the lamp control code found in Step (VII), so as to make the execution module control the lamp input power supply to be on/off, thereby allowing rhythmed on/off change of the light-emitting unit electrically connected to this execution module; until the central control module controls the execution module to complete the action appointed by the lamp control code, returning to Step (V) to continue.

The music flasher controller of the present invention and the control system and control method thereof have the following beneficial effects: With a music flasher controller of reasonable design and simple operation as well as a music flasher control system equipped with the music flasher controller, the disadvantages of the existing technology such as complex installation, difficult construction, high cost, low scalability, and single transformation form are effectively solved, providing the advantages such as simple installation and low cost; the present invention also provides a control method for the music flasher controller, such that the lamp can be on/off with the music rhythm simply and easily.

Compared with the existing technology, the music flasher controller of the present invention and the control system and control method thereof also have the following advantages:

1. Easy construction, and low cost: what is needed for installation is simply to connect the power plug of the lamp to the socket of the music flasher controller and then to play the music with the player (e.g. stereo and speakers) that has been encoded by the music encoding module, with no professional installation needed;

2. simple installation: with the music encoded, the music encoding-playing device can be separated from the music signal collecting-processing control device, and the player does not need to be wire-connected to the collecting module;

3. easy maintenance: the music flasher controller is simple in installation and structure, and the music playing source is separated from the music receiving-processing terminal, very convenient for future maintenance;

4. high scalability: with the music flasher control system composed of one music encoding-playing device and at least one music signal collecting-processing control device, the music signal played by the player in one music encoding-playing device can be collected simultaneously by the signal collecting module in a plurality of music signal collecting-processing control devices, thus the number of the lamp group can be increased by increasing the number of the music signal collecting-processing control device, and thereby a user can flexibly change the number of the lamp group according to personal fondness and requirement;

5. simple update of the music source: if the music needs to be updated, the music source can be updated simply through encoding of the new music by the music encoding module and then playing by the player, which has no need to change or upgrade the device hardware, and thus has low cost and simple operation;

6. high flexibility in free change and combination of the lamp group: when the combination of the lamp group needs to be changed, the lamp group may have different change and combination according to the different music code simply by changing the music code of the music through the music encoding module, which is highly flexible; and

7. the lamp has a variety of forms, and can be changed variously with the music rhythm simply and easily: a comparison is made between the lamp control code saved in the central control module and the music code: if the lamp control code consistent with the music code is found, the action appointed by the lamp control code will be executed, thereby allowing rhythmed on/off change of the lamp.

The music flasher controller of the present invention and the control system and control method thereof will further be described below with reference to drawings and examples.

### BRIEF DESCRIPTION OF THE DRAWINGS

FIG. 1 is a block schematic diagram of the structure principle of Example 1 of the music flasher controller of the present invention;

FIG. 2 is a block schematic diagram of the structure principle of Example 2 of the music flasher controller of the present invention;

FIG. 3 is a schematic diagram of the system structure of Example 2 of the music flasher controller of the present invention; and

FIG. 4 is a block diagram of control logic of the music flasher controller of the present invention.

### DETAILED DESCRIPTION OF THE INVENTION

The music flasher controller of the present invention and the control system and control method thereof have the following most preferred examples that, however, cannot thereby limit the extent of protection of the present invention.

### Example 1

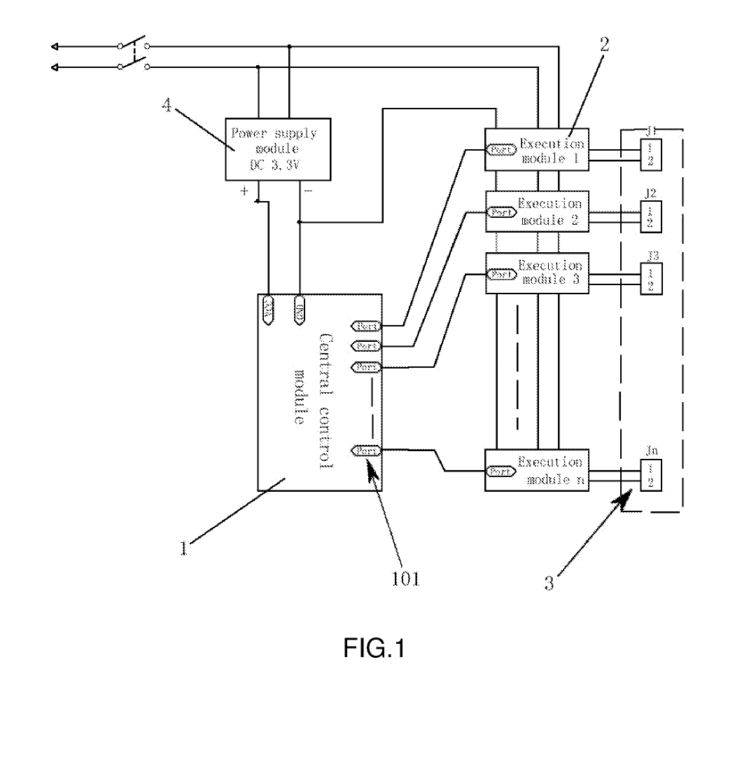

As shown in FIG. 1, a music flasher controller is provided, comprising:

a central control module 1 used for saving lamp control codes, each of the lamp control code having an appointed action to control the on/off change of different lamps, the central control module 1 being provided with a plurality of control output interfaces 101;

a plurality of execution modules 2, each of the execution modules 2 being respectively connected to a control output interface at its input terminal and to a lamp input power supply for controlling the lamp input power supply to be on/off, the number of the execution module 2 being determined according to the actual conditions;

a plurality of light-emitting units 3, each of the light-emitting units 3 being respectively electrically connected to one of the execution modules 2, each of the light-emitting units 3 being respectively composed of one lamp or one group of the lamps, the number of the light-emitting unit 3 and the lamp being determined according to the actual conditions, a flasher or a lamp in other forms being used as the lamp; and

a power supply module 4, used for providing power supply for each of the modules.

While installation, what is needed is simply to connect the power plug of the lamp to the socket of the music flasher controller, which is less difficult, needs no professional installation, and has low cost. While operation, the power supply is connected to make the central control module 1 initialized, which then controls the execution module 2 according to the saved lamp control codes to execute the action appointed by the lamp control code, thus controlling the lamp input power supply to be on/off, thereby allowing rhythmed on/off change of the lamp, with a user here only needing to synchronously play the adapted music, thus having the advantages of simple and easy operation.

### Example 2

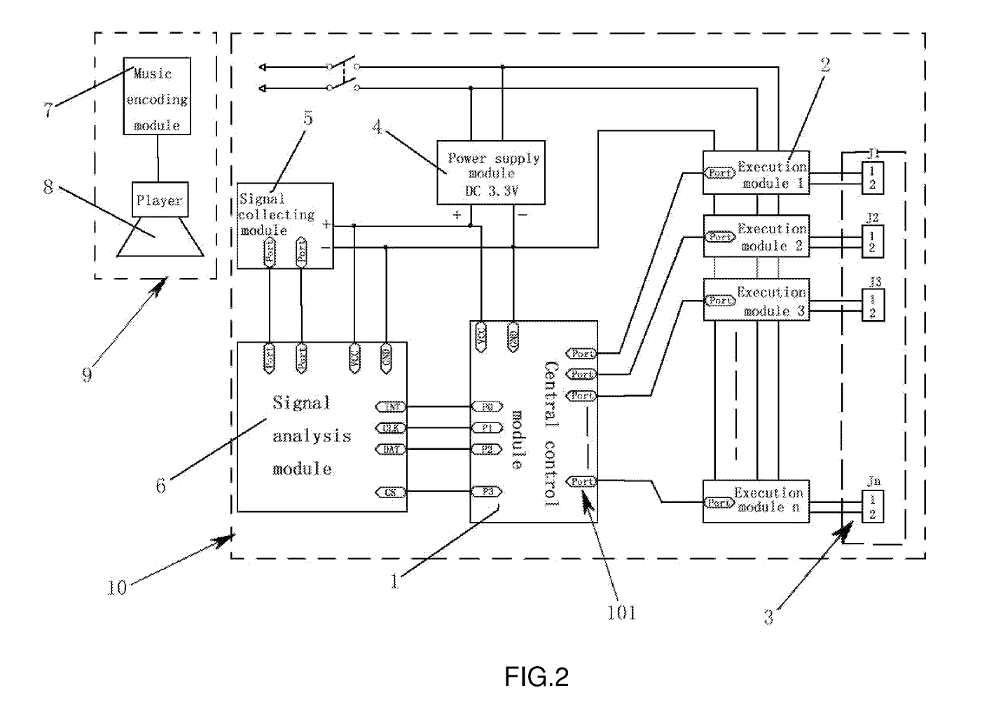

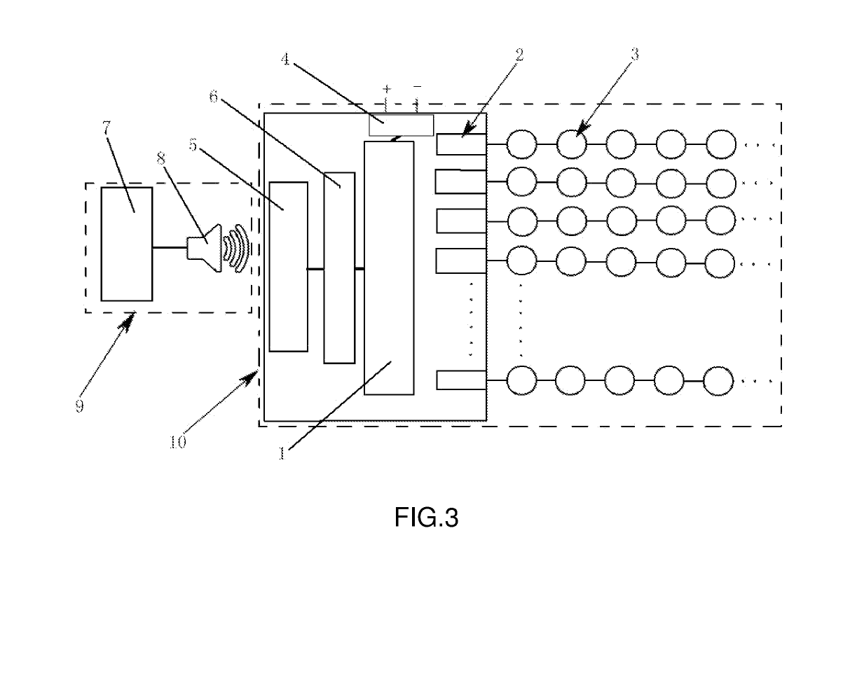

As shown in FIGS. 2, 3 and 4, a music flasher controller is provided, comprising:

a central control module 1 used for saving lamp control codes, each of the lamp control code having an appointed action to control the on/off change of different lamps, the central control module 1 being provided with a plurality of control output interfaces 101;

a plurality of execution modules 2, each of the execution modules 2 being respectively connected to a control output interface at its input terminal and to a lamp input power supply for controlling the lamp input power supply to be on/off, the number of the execution module 2 being set according to the actual needs;

a plurality of light-emitting units 3, each of the light-emitting units 3 being respectively electrically connected to one of the execution modules 2, each of the light-emitting units 3 being respectively composed of one lamp or one group of the lamps, the number of the light-emitting unit 3 being set according to the actual needs, the number of the lamp of each of the light-emitting units 3 being set according to the actual needs, a flasher or a lamp in other forms being used as the lamp; and

a power supply module 4, used for providing power supply for each of the modules.

It further comprises:

a music encoding module 7, used for encoding music;

a player 8, connected to the music encoding module 7, used for playing the music having been encoded by the music encoding module 7;

a signal collecting module 5, used for collecting music played by the player 8;

a signal analysis module 6, connected at its input terminal to an output terminal of the signal collecting module 5 and at its output terminal to an input terminal of the central control module 1, used for analyzing a music signal collected by the signal collecting module 5 to obtain music code of the music played by the player 8 as well as inputting the obtained music code into the central control module 1; and

the music encoding module 7 and the player 8 constitute a music encoding-playing device 9; and the signal collecting module 5, the signal analysis module 6, the central control module 1, a plurality of the execution modules 2, a plurality of the light-emitting units 3 and the power supply module 4 constitute a music signal collecting-processing control device 10.

The present invention further provides a music flasher control system equipped with the music flasher controller of this example, the system being composed of one music encoding-playing device 9 and at least one music signal collecting-processing control device 10.

The music added with the music code that is played by the player 8 in the music encoding-playing device 9 can be collected simultaneously by the signal collecting module 5 in a plurality of music signal collecting-processing control devices 10; when the number of the lamp group needs to be increased, the number of the lamp group can be increased simply by increasing the number of the music signal collecting-processing control device 10, and a user can flexibly change the number of the lamp group according to personal fondness and requirement, which has high scalability; the music encoding-playing device 9 is wire-connected to the music signal collecting-processing control device 10, which makes the installation simple and easy, with the number of the music signal collecting-processing control device 10 being set according to the actual needs.

The player 8 can be a sound box, a speaker or any other player.

While installation, what is needed is simply to connect the power plug of the lamp to the socket of the music flasher controller, which is simple in installation; while operation, the power supply is connected to make the central control module 1 initialized; here the player 8 plays the related music having been encoded by the music encoding module 7; the signal collecting module 5 collects the music signal played by the player 8, and inputs the collected music signal into the signal analysis module 6 for real-time analysis, so as to obtain music code of the music played by the player 8; the central control module 1 compares the music code obtained from analysis by the signal analysis module 6 with the saved lamp control codes, and analyzes: if the lamp control code consistent with the music code is found, the central control module 1 controls the execution module 2 to execute the action appointed by the lamp control code to control the lamp input power supply to be on/off, thereby controlling rhythmed on/off change of the light-emitting unit 3 electrically connected to this execution module 2; if the music needs to be updated, what is needed is only to encode the new music by the music encoding module (7) and then play by the player 8 the music encoded by the music encoding module 7, thereby updating the music source, which has simple operation and low cost; by changing the music code of the played music, the combination of the lamp can then be changed, and the rhythmed on/off change of the lamp can be realized, making the music light show diverse in form and flexible, thereby satisfying different needs of the market.

### Example 3

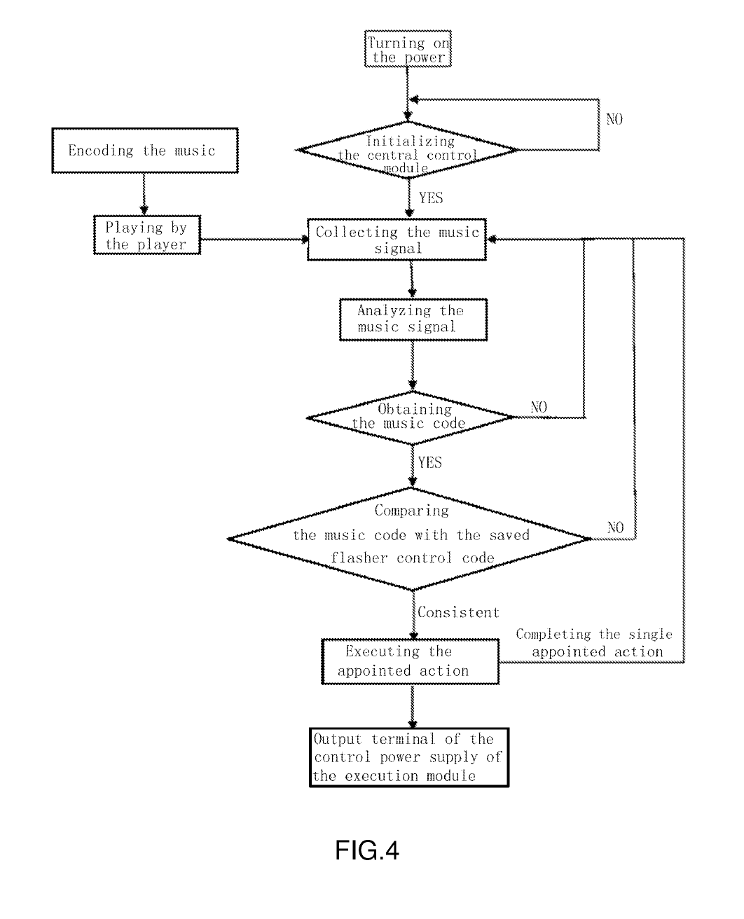

As shown in FIGS. 2 and 4, the present invention also provides a control method for the music flasher controller, which includes the following steps:

(I) Writing the lamp control code into the central control module 1;

(II) connecting the power supply module 4 to initialize the central control module 1 into which the lamp control code has been written in Step (I);

(III) encoding the music with the music encoding module 7;

(IV) the player 8 plays the music that has been encoded in Step (III);

(V) the signal collecting module 5 collects the music signal played in Step (IV), and inputs the collected music signal into the signal analysis module 6;

(VI) the signal analysis module 6 real-time analyzes the music signal collected in Step (V): if the music code of the music played in Step (IV) is obtained through analysis, the obtained music code is inputted into the central control module 1 followed by a next step, otherwise returning to Step (V) to continue;

(VII) the central control module 1 searches and analyzes, and compares the music code inputted in Step (VI) with the saved lamp control codes: if the lamp control code consistent with the music code inputted in Step (VI) is found, entering a next step, otherwise returning to Step (V) to continue; and

(VIII) the central control module 1 controls the execution module 2 to execute an action appointed by the lamp control code obtained in Step (VII), thus controlling the lamp input power supply to be on/off, thereby allowing rhythmed on/off change of the light-emitting unit 3 electrically connected to this execution module 2; until the central control module 1 controls the execution module 2 to complete the action appointed by the lamp control code, returning to Step (V) to continue.

In Step (VIII), the action appointed by the lamp control code may be one action or a group of actions; the action appointed by the lamp control code is specifically used to control the different execution module 2 to input into the lamp an action instruction for making the power supply on/off, thereby controlling the different lamps to be on/off.

In Step (VIII), the execution module 2 may be one execution module or a plurality of execution modules, and the number of the execution module 2 is set according to the actual lamp control instruction.

In Step (VIII), the light-emitting unit 3 is composed of one lamp or a group of lamps, the number of lamps is determined according to the actual conditions, and a flasher or a lamp in other forms can be used as the lamp.

The above examples are preferred embodiments of the present invention. However, the embodiments of the present invention are free from restriction of the above examples; and any other modification, amendment, replacement, combination and simplification not departing from the spirit and principle of the present invention shall be the equivalent permutation method, and all fall within the extent of protection of the present invention.

What is claimed is:

1. A music flasher controller, characterized in that it comprises:
a central control module (1), used for saving lamp control codes, provided with a plurality of control output interfaces (101);
a plurality of execution modules (2), each of the execution modules (2) being respectively connected to a control output interface (101) at its input terminal and to a lamp input power supply for controlling the lamp input power supply to be on/off;
a plurality of light-emitting units (3), each of the light-emitting units (3) being electrically connected to one of the execution modules (2), respectively; and
a power supply module (4), used for providing power supply for each of the modules.

2. The music flasher controller according to claim 1, characterized in that each of the light-emitting units (3) is composed of one lamp or one group of the lamps, respectively.

3. The music flasher controller according to claim 1, characterized in that it further comprises:
a music encoding module (7), used for encoding music;
a player (8), connected to the music encoding module (7), used for playing the music having been encoded by the music encoding module (7);
a signal collecting module (5), used for collecting a music signal played by the player (8);
a signal analysis module (6), connected at its input terminal to an output terminal of the signal collecting module (5) and at its output terminal to an input terminal of the central control module (1), used for analyzing the music signal collected by the signal collecting module (5) to obtain the music code of the music played by the player (8) as well as inputting the obtained music code into the central control module (1);
the music encoding module (7) and the player (8) constitute a music encoding-playing device (9); and the signal collecting module (5), the signal analysis module (6), the central control module (1), a plurality of the execution modules (2), a plurality of the light-emitting units (3) and the power supply module (4) constitute a music signal collecting-processing control device (10).

4. A music flasher control system equipped with the music flasher controller according to claim 3, characterized in that the system is composed of one music encoding-playing device (9) and at least one music signal collecting-processing control device (10).

5. A control method for the music flasher controller according to claim 3, characterized in that it includes the following steps:
(I) writing the lamp control code into the central control module (1);
(II) connecting the power supply module (4) to initialize the central control module (1) into which the lamp control code has been written in Step (I);
(III) encoding the music with the music encoding module (7);
(IV) the player (8) plays the music that has been encoded in Step (III);
(V) the signal collecting module (5) collects the music signal played in Step (IV), and inputs the collected music signal into the signal analysis module (6);
(VI) the signal analysis module (6) real-time analyzes the music signal collected in Step (V): if the music code of the music played in Step (IV) is obtained through analysis, the obtained music code is inputted into the central control module (1) followed by a next step, otherwise returning to Step (V) to continue;
(VII) the central control module (1) searches and analyzes, and compares the music code inputted in Step (VI) with the saved lamp control codes: if the lamp control code consistent with the music code inputted in Step (VI) is found, entering a next step, otherwise returning to Step (V) to continue; and
(VIII) the central control module (1) controls the execution module (2) to execute an action appointed by the lamp control code found in Step (VII), so as to make the execution module (2) control the lamp input power supply to be on/off, thereby allowing rhythmed on/off change of the light-emitting unit (3) electrically connected to this execution module (2); until the central control module (1) controls the execution module (2) to complete the action appointed by the lamp control code, returning to Step (V) to continue.

6. The control method according to claim 5, characterized in that in Step (VIII) the action appointed by the lamp control code may be one action or a group of actions.

7. The control method according to claim 5, characterized in that in Step (VIII) the execution module (2) may be one execution module or a plurality of execution modules.

8. The control method according to claim 5, characterized in that in Step (VIII) the light-emitting unit (3) is composed of one lamp or a group of lamps.
